(19) United States
(12) Patent Application Publication
(10) Pub. No.: US 2007/0076859 A1
(43) Pub. Date: Apr. 5, 2007

(54) Keyboard with additional indicia

(76) Inventor: Milen Petkov Tzvetanov, Palmyra, NJ (US)

Correspondence Address: Stephen G. Stanton, Esq., 428 Hilltop Road, Paoli, PA, 19301-1213, US

(21) Appl. No.: 11/540,101

(22) Filed: Sep. 29, 2006

Related U.S. Application Data
(60) Provisional application No. 60/722,881, filed on Sep. 30, 2005.
(60) Provisional application No. 60/729,703, filed on Oct. 24, 2005.

(51) Int. Cl. H04M 11/00

(52) U.S. Cl. 379/93.09

(57) ABSTRACT

A keyboard comprising: (1) one or more rows of letter indicia entry keys and/or number indicia entry keys; and (2) additional indicia positioned over or proximate to at least a selected portion of said letter indicia entry keys and/or said number indicia entry keys to facilitate placement of telephone calls or entry of alphanumerical data. A method of facilitating placement of telephone calls or entry of alphanumerical data using a keyboard having one or more rows of letter indicia entry keys and/or number indicia entry keys, including the step of positioning additional indicia over or proximate to at least a selected portion of said letter indicia entry keys and/or said number indicia entry keys. A keyboard comprising: (1) one or more rows of letter indicia entry keys adapted for operating in a first mode and a second mode; and a series of individual numbers associated with at least a portion of the letter indicia entry keys wherein in the first mode the letter indicia entry keys correspond to letters of an alphabet and in the second mode the letter indicia entry keys correspond to the associated individual numbers.

This application claims the benefit of U.S. Provisional Patent Application No. US60/722,881 filed Sep. 30, 2005 and U.S. Provisional Patent Application No. US60/729,703 filed Oct. 24, 2005.

### FIELD OF THE INVENTION

This invention relates generally to keyboards or other input devices for computer systems and electronic and communication devices.

### BACKGROUND OF THE INVENTION

An example of input device, a conventional (computer) keyboard 10 having letter/alphabet indicia entry keys 14, numerical indicia entry keys 16 and symbol/function indicia entry keys 18 is shown in FIG. 1 with an enlarged portion of the numerical keys 16 shown at 12. As shown several numerical keys 16 and symbol/function keys 18 may have more than one indicia. For example the number 16 “4” includes a “$” operable by simultaneously pressing the SHIFT key, for example.

In many cases telephone and fax numbers contain letters. For example, a number can be presented and advertised in an easy to remember format such as, for example, 1-800-TALK-2-ME. When someone needs to dial a number presented in such format, he or she will need to check the dial pad on a telephone apparatus to see what numbers correspond to these letters and then dial the number from the machine (computer). A typical conventional telephone keypad 20 is shown in FIG. 2 with groupings of letters of the alphabet affixed to key numbers 2 through 9 and “OPER” for operator affixed to key number 0.

U.S. Patent Publication No. US 2005/0245293 A1 to Provencher et al. describes a computer keyboard having hybrid computer/telephone keypad.

U.S. Patent Publication No. US 2002/0150416 A1 to VanDruff describes a modal computer keyboard stenography emulation apparatus and method.

U.S. Patent Publication No. US 2002/0015609 A1 to Webber describes a modular ergonomic multi-function, multi-layer, universal standard keyboard.

U.S. Pat. No. 6,868,145 B1 to Nelson describes an alphanumeric keyboard with telephone dialing capability.

U.S. Pat. No. 6,281,812 B1 to Kim describes a computer having LED display keyboard device.

U.S. Pat. No. 5,375,165 to Haber et al. describes a computer keyboard having both a standard keyboard mode and a telephone control mode.

U.S. Pat. No. 5,253,940 to Abecassis describes a user selectable numeric keycaps layout.

U.S. Pat. No. 4,860,342 to Danner describes a computer-telephone interface method and apparatus.

### SUMMARY OF THE INVENTION

A keyboard comprising: (1) one or more rows of letter indicia entry keys and/or number indicia entry keys; and (2) additional indicia positioned over or proximate to at least a selected portion of the letter indicia entry keys and/or said number indicia entry keys to facilitate placement of telephone calls or entry of alphanumerical data. A method of facilitating placement of telephone calls or entry of alphanumerical data using a keyboard having one or more rows of letter indicia entry keys and/or number indicia entry keys, including the step of positioning additional indicia over or proximate to at least a selected portion of said letter indicia entry keys and/or said number indicia entry keys. A keyboard comprising: (1) one or more rows of letter indicia entry keys adapted for operating in a first mode and a second mode; and a series of individual numbers associated with at least a portion of the letter indicia entry keys wherein in the first mode the letter indicia entry keys correspond to letters of an alphabet and in the second mode the letter indicia entry keys correspond to the associated individual numbers.

### BRIEF DESCRIPTION OF THE DRAWINGS

FIG. 1 is a schematic illustration of a conventional keyboard layout.

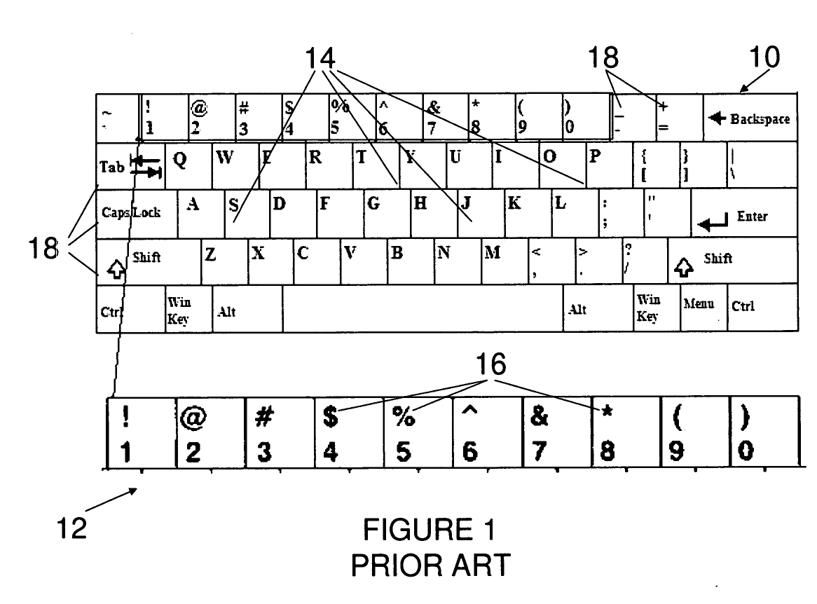

FIG. 2 is a schematic illustration of a conventional telephone dial pad.

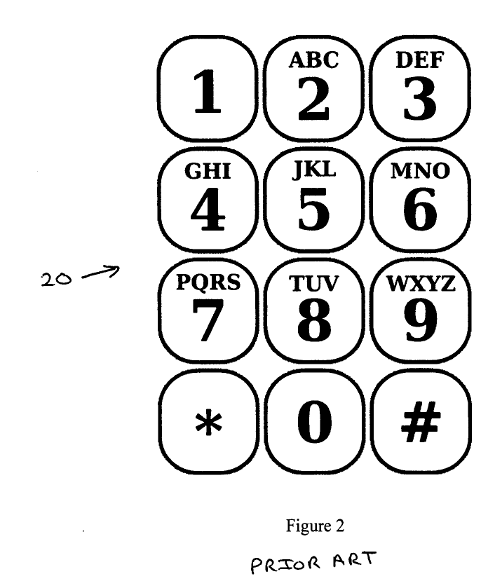

FIG. 3 is a schematic illustration of exemplary embodiments of the present invention.

FIG. 4 is a schematic illustration of another exemplary embodiments of the present invention.

FIG. 5 is a schematic illustration of yet other exemplary embodiments of the present invention.

FIG. 6 is a schematic illustration of a number indicia entry key illustrating more exemplary embodiments of the present invention.

FIG. 7 is a schematic illustration of another exemplary embodiment of the present invention.

FIG. 8 is a schematic illustration of other exemplary embodiments of the present invention.

FIG. 9 is a schematic illustration of yet another exemplary embodiment of the present invention.

FIG. 10 is a schematic illustration of another exemplary embodiment of the present invention.

FIG. 11 is a schematic illustration of yet another exemplary embodiment of the present invention.

### DETAILED DESCRIPTION OF THE PREFERRED EMBODIMENT

The present invention relates to input-output devices for electronic and communication machines such as, for example, keyboards, keypads, computers, smart phones, Personal Digital Assistants (PDAs) with telephone capabilities. In particular, the subject invention relates to enabling the input devices (keyboards) to be used for easy dialing of telephone (or other) numbers from electronic machines (computers). For example, the numbers so entered could be personal identification numbers (PINs) or the like for secure financial or other transactions. This would permit PIN numbers or other secure series of numbers and or letters to correspond to words comprised of letters of an alphabet to facilitate memorization of such numbers. For example a PIN could be HELP that could be 4357 as will be understood by a proper reading of the specification.

For example, inter alia, with the teachings of the present invention, the numbers that contain letters can be dialed easily from input devices (computer keyboards, smart phones keypad), without the need for checking the telephone dial pad to determine what numbers correspond to the letters.

As a further example, inter alia, additional indicia/labeling is applied on/proximate to the keys of input devices used for entering numbers for electronic and communication machines such as, for example, computers, smart phones, PDAs, broadcasting interfaces and Internet terminals. The labeling may add letter indicia to the numerical indicia entry keys that may correspond to telephone keypad labeling. This may improve the functionality of standard input devices and makes it easier to enter phone numbers that contain letters from the input devices (such as, for example, an interface keyboard, a keypad).

The present invention may relate to input and/or output devices for, inter alia, electronic and communication machines such as computers, smart phones, Personal Digital Assistants with telephone capabilities (PDAs), Internet terminals, radios, interactive radios, broadcasting interfaces or systems such as TV (television) or Web TV. In particular, the subject invention relates to enabling the input devices (keyboard) to be used for easy entering of numbers to electronic machine and communication devices (computer).

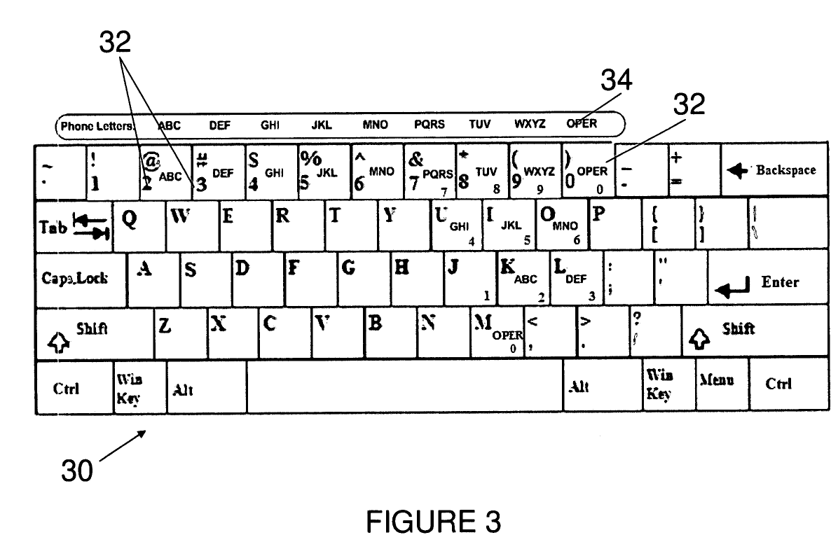

### First Exemplary Embodiment of the Present Invention—FIG. 3

As illustrated in FIG. 3, in a first exemplary embodiment of the present invention, numerical indicia entry keys 32 (1 through 9 inclusive and 0) of the keyboard/input device 30 have additional indicia/characters, such as alphabetic indicia/letters that correspond to the letters found on, for example, telephone dialing keypads, positioned over or proximate to corresponding numerical indicia entry keys.

The additional indicia/characters can differ based on the keyboard country (local) specifics. For example, the keyboard used in the USA will have the letters from the Latin alphabet on the numeric keys in the following format and order:
Numeric key 2 will have ABC;
Numeric key 3 will have DEF;
Numeric key 4 will have GHI;
Numeric key 5 will have JKL;
Numeric key 6 will have MNO;
Numeric key 7 will have PQRS;
Numeric key 8 will have TUV;
Numeric key 9 will have WXYZ; and
Numeric key 0 will have OPER (for operator).

The numerical indicia input keys 32 may have different locations on keyboards 30 that are designed and used in different countries. When a country uses other characters on the phone-dialing pad, the keyboard 30 that is used in such country will have these specific non-numeric characters on its numerical indicia entry keys.

For convenience, we may call these non-numerical indicia/characters used in phone numbers, “telephone characters”.

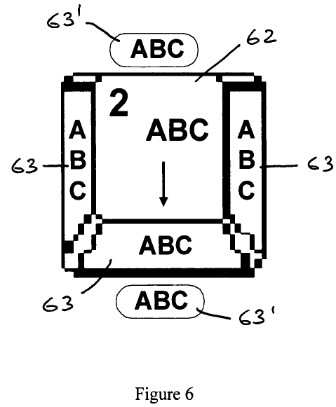

The telephone characters can be positioned over/placed on numerical indicia entry keys 32 the same way as all other characters are placed on the keys 32, e.g. paint, use of an alternative color for the new telephone characters, use of a sticker, or by change of the key's surface (for example at the time keys 32 are manufactured or thereafter). The telephone character can be placed on the top of the key, near the numeric character, or on any one of the key's sides (see FIG. 6, for example). It is noted that holds for the remaining embodiments of the present invention as applicable.

Also as shown in FIG. 3, the telephone characters may be positioned proximate to numerical indicia entry keys 32 such as on a, for example, strip 34 having the telephone characters, for example, above numerical indicia entry keys 32. It is noted that strip 34 may also be placed below numerical indicia entry keys 32 on keyboard designs having sufficient space there below and that separate labels or the like may be placed beside numerical indicia entry keys 32 on keyboard designs having sufficient space thereby. It is noted that holds for the remaining embodiments of the present invention as applicable.

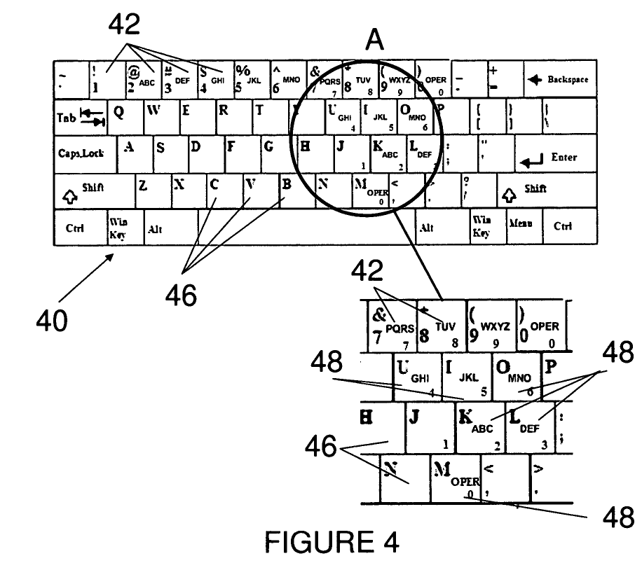

### Second Exemplary Embodiment of the Present Invention—FIG. 4

As illustrated in FIG. 4, in a second exemplary embodiment of the present invention, specifically illustrates a so-called compact keyboard 40 used, for example, on laptop computers, wherein in addition to numerical indicia entry keys 42, located above letter indicia entry keys 46, 48, the telephone characters are also positioned over or proximate to letter indicia keys 48 that can be activated when a “NumLk” (number lock or the like) key is depressed/activated. Letter indicia entry keys 48 may be positioned below numerical indicia entry keys 42 having numbers “7,” “8,” “9” and “0” (see the enlarged portion of keyboard 40 at circle “A”) as shown in FIG. 4.

It is noted that the grouping of letter indicia keys 48 may be located elsewhere on keyboard 40 in which instance other letter indicia keys 46 may take the place of numerical indicia entry keys 42 having numbers “7,” “8,” “9” and “0”.

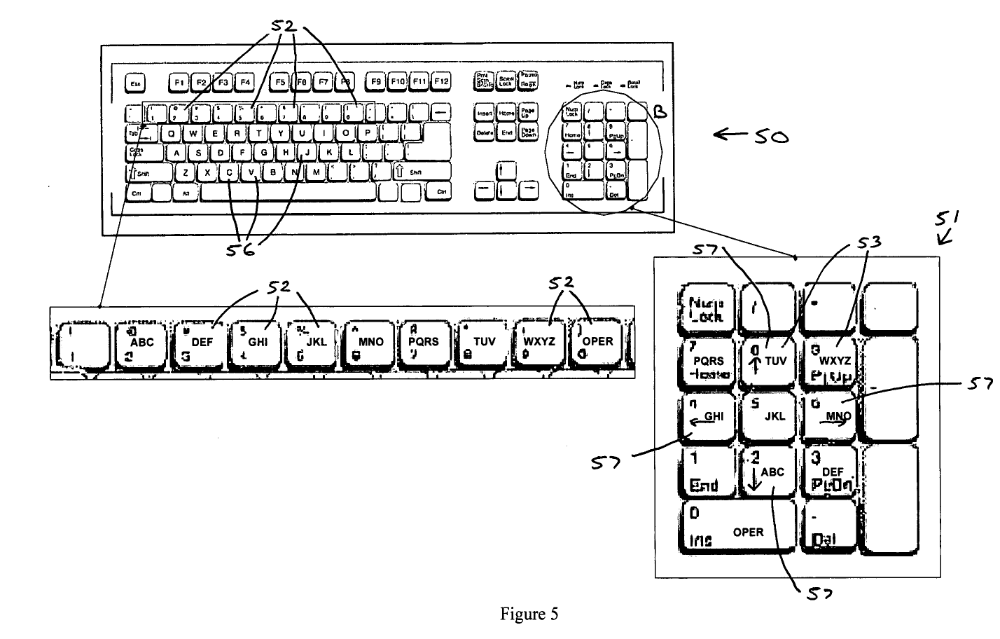

### Third Exemplary Embodiment of the Present Invention—FIG. 5

As illustrated in FIG. 5, in a third exemplary embodiment of the present invention, the telephone characters may be applied on any key that can be used as a numeric key with the keyboard's functionality. For example, on a 102-key keyboard 50, the telephone characters are applied on the numerical indicia entry keys 52 above the letter indicia entry keys 56 (see the enlarged portion of keyboard 50 at rectangle “C”) and are also applied on numerical indicia entry keys 53 on number pad 51, at the right hand side of the keyboard (see the enlarged portion of keyboard 50 at circle “B”). The functionality of numerical indicia entry keys 53 (and any navigation entry keys 57) on number pad 51 may be enabled by a “NumLk” (number lock) key.

On compact keyboards (e.g. used in laptops), in addition to the numerical indicial input keys 52 located above letter indicia input keys 56, the telephone characters can be applied on the keys that can be turned into numeric keys when used with enhanced functionality key, e.g. by pressing the “function key” (Fn).

### Fourth Exemplary Embodiment of the Present Invention—FIG. 6

As illustrated in FIG. 6, in a fourth exemplary embodiment of the present invention, an exemplary (numerical) indicia entry key 62 is illustrated having an exemplary telephone characters 63 (1) positioned over indicia entry key 62 at either the left side, the right side, the lower face or on the upper face or (2) proximate indicia entry key 62 above or below indicia entry key 62 as shown. It is noted that telephone characters 63 may also be proximate indicia entry key 62 on its left or right side or at another proximate position (not shown). The telephone characters 63 may be positioned over or proximate to indicia entry key 62 at only one, any or all the positions illustrated in FIG. 6 (or as described above).

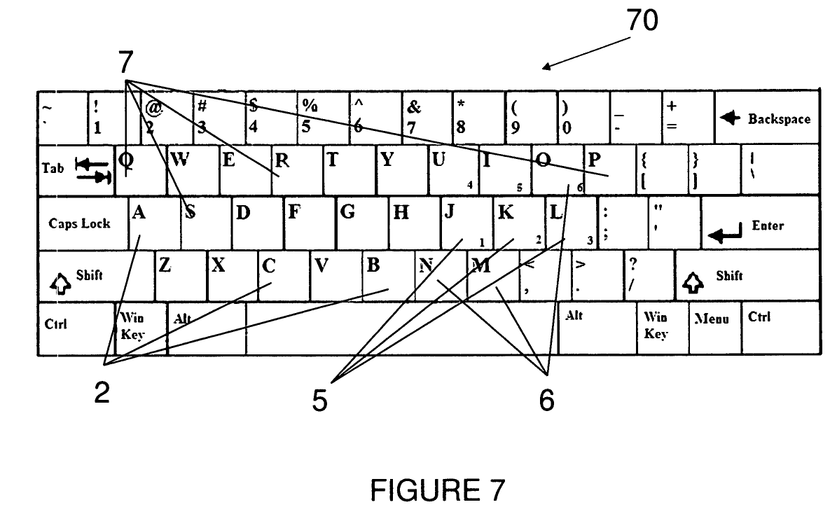

### Fifth Exemplary Embodiment of the Present Invention—FIG. 7

As illustrated in FIG. 7, in a fifth exemplary embodiment of the present invention, with electronic modification (by software or hardware for example) of the electronic machine (computer, smart phone, PDA) or of the input device, the letter keys of the input device can be turned into numeric mode, when the keystrokes are transformed into number entry. The numbers correspond to the letters that can be found on the telephone dialing keypad. The mapping of letters and numbers follows this logic:
Keys for the letters A, B, and C results in numeric input ‘2’
Keys for the letters D, E, and F results in numeric input ‘3’
Keys for the letters G, H, and I results in numeric input ‘4’
Keys for the letters J, K, and L results in numeric input ‘5’
Keys for the letters M, N, and O results in numeric input ‘6’
Keys for the letters P, Q, R, and S results in numeric input ‘7’
Keys for the letters T, U, and V results in numeric input ‘8’
Keys for the letters W, X, Y, and Z results in numeric input ‘9’
There are no letter keys that will translate into numeric entry 0.

It is noted that there are no additional number indicia that are seen in association with the respective letter indicia entry keys.

Referring to FIG. 7 for keyboard 70: the number “2” would be associated to the letter indicia entry keys for “A,” “B” and “C;” the number “5” would be associated with the letter indicia entry keys for “J,” “K” and “L;” the number “6” would be associated with the letter indicia entry keys for “M,” “N” and “O;” and the number “7” would be associated with the letter indicia entry keys for “P,” “Q,” “R” and “S.” This would also be done for the number 3 (for letter entry keys D, E and F), 4 (for letter entry keys G, H and I), 8 (for letter entry keys T, U and V) and 9 (for letter entry keys W, X, Y and Z). Again, there would be no association of the numbers 1 or 0 for any letter entry keys for this embodiment.

The “number” mode of letter keys may be activated by, for example, pressing a special key (hot-key) or a combination of keys. For example Alt or Command, or by pressing a combination of keys, for example Ctrl+Shift, Alt+Shift, etc., depending upon the type of computer or device. As a result, when the numeric mode of the letter keys is enabled, and user enters 1-800-TALK-2-ME, that will result into input of this numeric string: 18008255263 that is used for dialing out a number. That is, the user will type the 1, 8, 0, 0, T, A, L, K, 2, M then E indicia entry keys to ‘dial’ the 18008255263 phone number. This mode may make entry of such “word phone numbers” more quickly and easily.

The ability to enable numeric mode of the letter keys may be done by, for example, a software driver in stalled on the computer, or by, for example, a build-in design of the keyboard electronic functionality or the electronic machine.

The electronic modifications (software or hardware), that allows the keyboard to have a numeric mode for the key letters would take under consideration the computer local settings. Therefore, it will enable different keys for the numbers depending on the country and local settings.

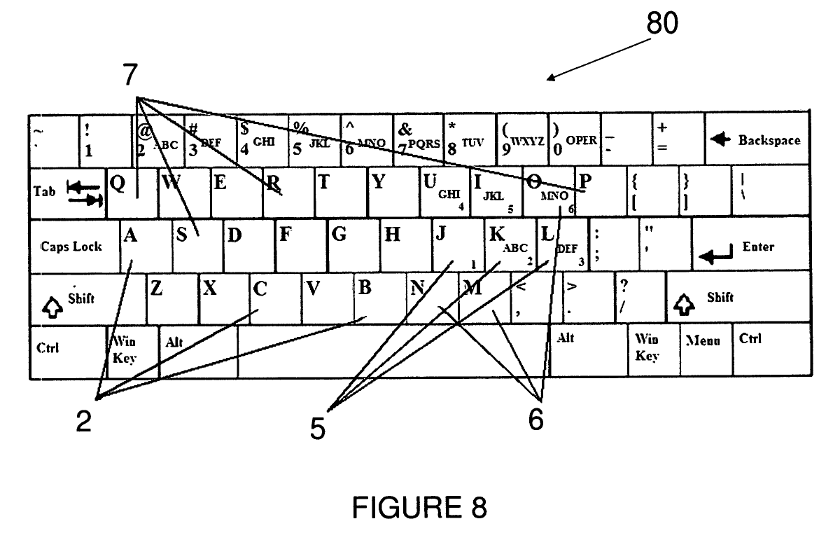

### Sixth Exemplary Embodiment of the Present Invention—FIG. 8

The sixth exemplary embodiment of the present invention is a combination of two or more of the above embodiments on a single keyboard/device. For example, the input devices of electronic machines (such as, for example, computers, smart phones, PDAs, etc.) can be enabled for easy entering of numbers that contain letters by using a combination of functional design (described above in the First Embodiment, for example) and electronic modification (described above in the Fifth Embodiment). Example of input device that can use a combination of these different methods is illustrated in, for example, FIG. 8 for keyboard 80.

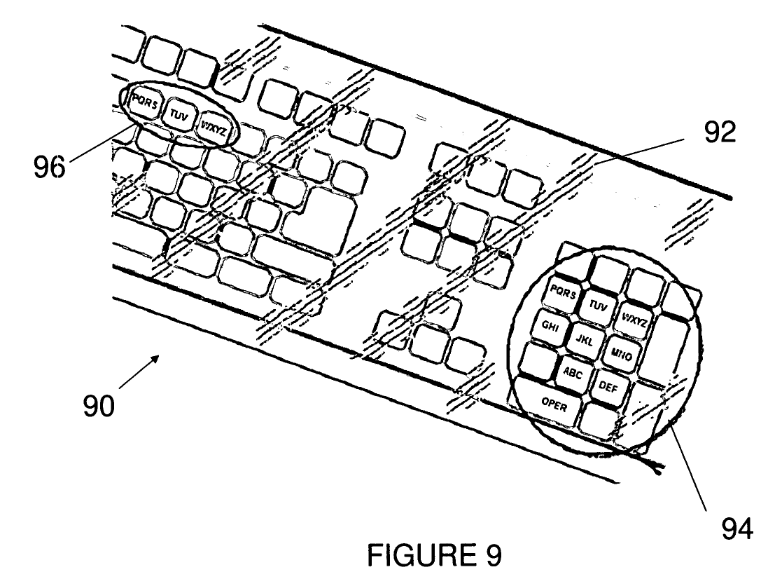

### Seventh Exemplary Embodiment of the Present Invention—FIGS. 9, 10 and 11

As illustrated in FIGS. 9, 10 and 11 in another exemplary embodiment of the present invention, the numeric keys of the input device (for example a computer keyboard) may be associated with alphabetic characters by using a cover or overlay 92, 102, 112 overlying the keys, where the letter indicia are applied on the cover/overlay instead of directly on the keys or keyboard. The cover can be for the entire input device or but a part of it. For example, a computer keyboard cover will have the alphabetic characters (letters) at the location that covers the numeric keys.

Such covers 92, 102, 112 may be flexible for ease of placement, removal and use. Such covers 92, 102, 112 may also be transparent or translucent so that the indicia on the underlying entry keys are easily visible. It is also noted that covers 92, 102, 112 may be opaque with only the indicia on covers 92, 102, 112 being discernable when in use. In that case, select indicia from the underlying entry keys may be included on covers 92, 102, 112 for ease of use in accordance with the teachings of the present invention.

FIG. 9 illustrates an exemplary cover 92 that will have these characters on it and once cover 92 is placed on keyboard 90, the keyboard's numeric keys may be enabled with the alphabetic letters 94, 96.

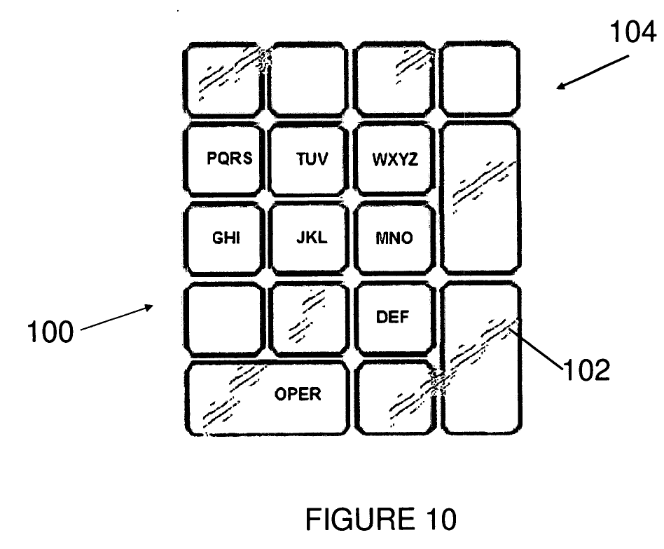

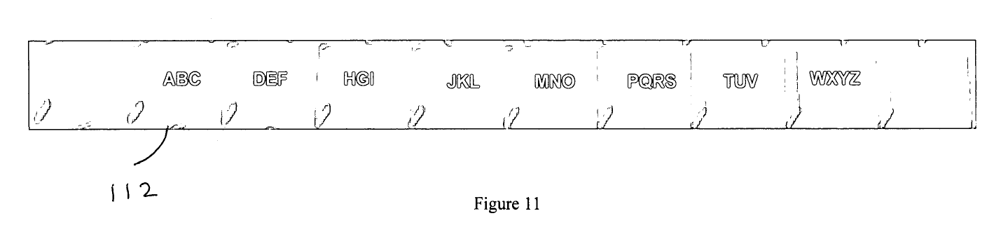

Cover 92 may also include only a portion 94 with additional alphabetic characters (letters) that can be also applied only on part of the input devices, for example only for the numeric keys. FIGS. 9 and 10 show examples of covers 92, 102 with portions 94, 96; 104 only for the numeric keys/the numeric input pad keys. FIG. 11 illustrates at least a portion of an exemplary cover 112 for placement over an upper horizontal row of number indicia entry keys 1 through 9 and 0. It is noted that “OPER” may also be included on the far right section for overlying the number 0 entry key.

Another option for associating alphabetic characters with numeric keys of input devices such as keyboards is the use of self adhesive labels (stickers) or strips (see FIG. 3, for example) that have the alphabetic characters on it. With stickers/strips that have the alphabetic characters organized in a way that correspond to the alphabetic characters on the telephone keypad, an input device (for example a computer keyboard) could be easily enabled with the functional design that allows easy dialing of numbers that contain letters.

It is understood that for any of the above relevant exemplary embodiments the specific way of associating the additional letter indicia and/or additional number indicia with the corresponding letter entry keys and or number entry keys so that the additional letter indicia and/or additional number indicia are positioned over or proximate to the letter entry keys and or number entry keys of the keyboard.

It is also noted for any of the above relevant exemplary embodiments that the additional indicia may also comprise symbols, pictograms or other information conveying indicia to be: (1) positioned over or proximate to at least a selected portion of the letter indicia entry keys and/or said number indicia entry keys; (2) associated with at least a selected portion of the letter indicia entry keys and/or said number indicia entry keys for the fifth exemplary embodiment described above, for example.

It is further noted that the teachings of the present invention may be applied to input and/or output devices for, inter alia, electronic and communication machines such as computers, smart phones, Personal Digital Assistants with telephone capabilities (PDAs), Internet terminals, radios, interactive radios, broadcasting interfaces or systems such as TV (television) or Web TV. In particular, the subject invention relates to enabling the input devices (keyboard) to be used for easy entering of numbers to electronic machine and communication devices (computer).

Given the variety of exemplary embodiments of the present invention just described, the above description and illustrations should not be taken as limiting the scope of the present invention defined by the claims.

While the invention has been particularly shown and described with reference to the preferred exemplary embodiments thereof, it will be understood by those skilled in the art that various changes in form and details may be made without departing from the spirit and scope of the invention. It is intended to cover various modifications and similar arrangements and procedures, and the scope of the appended claims therefore should be accorded the broadest interpretation so as to encompass all such modifications and similar arrangements and procedures.

I claim:

1. A keyboard, comprising:
one or more rows of letter indicia entry keys and/or number indicia entry keys; and
additional indicia positioned over or proximate to at least a selected portion of said letter indicia entry keys and/or said number indicia entry keys to facilitate placement of telephone calls or entry of alphanumerical data.

2. The keyboard of claim 1, wherein said one or more rows of letter indicia entry keys and/or number indicia entry keys includes a row of number indicia entry keys from 1 through 9 inclusively and 0 (zero) wherein said additional indicia comprise letter indicia of a select alphabet portioned in discrete and distinct letter groupings of said select alphabet positioned over or proximate to said 1 through 9 number indicia entry keys.

3. The keyboard of claim 1, wherein said one or more rows of letter indicia entry keys and/or number indicia entry keys includes a row of number indicia entry keys from 1 through 9 inclusively and 0 (zero) wherein said additional indicia comprise letter indicia of a select alphabet portioned in discrete and distinct letter groupings of said select alphabet positioned over or proximate to said 1 through 9 number indicia entry keys in that letters:
ABC are positioned over or proximate to number indicia key 2;
DEF are positioned over or proximate to number indicia key 3;
GHI are positioned over or proximate to number indicia key 4;
JKL are positioned over or proximate to number indicia key 5;
MNO are positioned over or proximate to number indicia key 6;
PQRS are positioned over or proximate to number indicia key 7:
TUV are positioned over or proximate to number indicia key 8;
WXYZ are positioned over or proximate to number indicia key 9; and
OPER are positioned over or proximate to number indicia key 0.

4. The keyboard of claim 1, wherein said one or more rows of letter indicia entry keys and/or number indicia entry keys includes a row of number indicia entry keys from 1 through 9 inclusively and 0 (zero) and rows of letter indicia entry keys below said row of number indicia keys, wherein said additional indicia comprise letter indicia of a select alphabet portioned in discrete and distinct letter groupings of said select alphabet positioned over or proximate to said 1 through 9 number indicia entry keys in that letters:
ABC are positioned over or proximate to number indicia key 2;
DEF are positioned over or proximate to number indicia key 3;
GHI are positioned over or proximate to number indicia key 4 and over a first letter indicia entry key below number indicia keys 7 and 8;
JKL are positioned over or proximate to number indicia key 5 and over a second letter indicia entry key below number indicia keys 8 and 9;
MNO are positioned over or proximate to number indicia key 6 and over a third letter indicia entry key below number indicia keys 9 and 0;
PQRS are positioned over or proximate to number indicia key 7:
TUV are positioned over or proximate to number indicia key 8;
WXYZ are positioned over or proximate to number indicia key 9;
OPER are positioned over or proximate to number indicia key 0;
ABC are positioned over or proximate to a fourth letter indicia entry key below said second and third letter indicia entry keys;
DEF are positioned over or proximate to a fifth letter indicia entry key below said third letter indicia entry keys; and
OPER are positioned over or proximate to a sixth letter indicia entry key below said fourth and fifth letter indicia entry keys.

5. The keyboard of claim 1, wherein said one or more rows of letter indicia entry keys and/or number indicia entry keys includes a keypad portion comprising:
an uppermost row having at least three number indicia entry keys corresponding to the numbers 7 to 9, wherein letters PQRS are positioned over or proximate to said number indicia key 7, letters TUV are positioned over said number indicia key 8, and letters WXYZ are positioned over or proximate to said number indicia key 9;
an upper middle row having at least three number indicia entry keys corresponding to the numbers 4 to 6, wherein letters GHI are positioned over or proximate to said number indicia key 4, letters JKL positioned over or proximate to said number indicia key 5, and letters MNO are positioned over or proximate to said number indicia key 6; and
a lower middle row having at least three number indicia entry keys corresponding to the numbers 1 to 3, wherein letters ABC are positioned over or proximate to said number indicia key 2 and letters DEF are positioned over or proximate to said number indicia key 3; and
a lower row having at least one number indicia entry key corresponding to the number 0 wherein letters OPER are positioned over or proximate to said number indicia key 0;
wherein said additional indicia comprise said letters ABC, DEF, GHI, JKL, MNO, PQRS, TUV, WXYZ and OPER.

6. The keyboard of claim 1, wherein for alphanumeric phone numbers having at least one or more letters therein, said letter indicia entry keys comprise an alphabet having letters A through Z, inclusive, said additional indicia comprise number indicia positioned over or proximate to select said letter indicia entry keys wherein:
number 2 is positioned over or proximate to said letter indicia entry keys A, B and C;
number 3 is positioned over or proximate to said letter indicia entry keys D, E and F;
number 4 is positioned over or proximate to said letter indicia entry keys G, H and I;
number 5 is positioned over or proximate to said letter indicia entry keys J, K and L;
number 6 is positioned over or proximate to said letter indicia entry keys M, N and O;
number 7 is positioned over or proximate to said letter indicia entry keys P, Q R and S;
number 8 is positioned over or proximate to said letter indicia entry keys T, U and V; and
number 9 is positioned over or proximate to said letter indicia entry keys W, X, Y and Z.

7. The keyboard of claim 1, wherein said additional indicia are:
a) on an overlying cover positioned over said one or more rows of letter indicia entry keys and/or number indicia entry keys; said additional indicia being positioned over or proximate to said corresponding selected portion of said letter indicia entry keys and/or said number indicia entry keys;
b) on labels affixed to or proximate to said selected portion of said letter indicia entry keys and/or said number indicia entry keys; or
c) permanently affixed to or proximate to said selected portion of said letter indicia entry keys and/or said number indicia entry keys.

8. The keyboard of claim 1, wherein said additional indicia are on an overlying flexible transparent or flexible translucent cover positioned over said one or more rows of letter indicia entry keys and/or number indicia entry keys; said additional indicia being positioned over or proximate to said corresponding selected portion of said letter indicia entry keys and/or said number indicia entry keys.

9. The keyboard of claim 1, wherein said one or more rows of letter indicia entry keys and/or number indicia entry keys comprise one or more rows of letter indicia entry keys.

10. The keyboard of claim 1, wherein said one or more rows of letter indicia entry keys and/or number indicia entry keys comprise one or more rows of number indicia entry keys.

11. The keyboard of claim 1, wherein said keyboard is a keyboard or keypad adapted for data input to electronic devices such as computers, smart phones, personal digital assistants (PDAs), broadcasting interfaces or Internet terminals.

12. The keyboard of claim 1, wherein said additional indicia are proximate to said at least a selected portion of said letter indicia entry keys and/or said number indicia entry keys.

13. The keyboard of claim 1, wherein there is no separate mode or operation required.

14. The keyboard of claim 1, wherein said additional indicia positioned over or proximate to at least a selected portion of said letter indicia entry keys comprise number indicia and said additional indicia positioned over or proximate to at least a selected portion of said number indicia entry keys comprise letter indicia.

15. A keyboard, comprising:
one or more rows of letter indicia entry keys, said one or more rows of letter indicia entry keys adapted for operating in a first mode and a second mode; and
a series of individual numbers associated with at least a portion of said letter indicia entry keys;
wherein in said first mode said letter indicia entry keys correspond to letters of an alphabet; and in said second mode said letter indicia entry keys correspond to said associated individual numbers.

16. The keyboard of claim 15, wherein:
said letter indicia entry keys include letters A through Z;
number 2 is associated with the letter indicia entry keys A, B and C;
number 3 is associated with the letter indicia entry keys D, E and F;
number 4 is associated with the letter indicia entry keys G, H and I;
number 5 is associated with the letter indicia entry keys J, K and L;
number 6 is associated with the letter indicia entry keys M, N and O;
number 7 is associated with the letter indicia entry keys P, Q R and S;
number 8 is associated with the letter indicia entry keys T, U and V; and
number 9 is associated with the letter indicia entry keys W, X, Y and Z.

17. A method of facilitating placement of telephone calls or entry of alphanumerical data using a keyboard having one or more rows of letter indicia entry keys and/or number indicia entry keys, including the step of:
positioning additional indicia over or proximate to at least a selected portion of said letter indicia entry keys and/or said number indicia entry keys.

18. The method of claim 17, wherein said positioning of said additional indicia comprises:
positioning additional numerical indicia over or proximate to at least a selected portion of said letter indicia entry keys; and/or
positioning additional letter indicia over or proximate to at least a selected portion of said number indicia entry keys.

19. The method of claim 17, further comprising:
adapting at least said one or more rows of letter indicia entry keys for operating in a first mode and a second mode;
wherein the additional indicia comprise a series of individual numbers associated with at least a portion of said letter indicia entry keys are placed electronically and are not discernable visually; and
wherein in said first mode said letter indicia entry keys correspond to letters of an alphabet; and in said second mode said letter indicia entry keys correspond to said associated individual numbers.
